(19) United States
(12) Patent Application Publication
(10) Pub. No.: US 2007/0013724 A1
(43) Pub. Date: Jan. 18, 2007

(54) Building of scaled physical models

(76) Inventor: Lawrence W. Swift, Potomac, MD (US)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/484,945

(22) Filed: Jul. 12, 2006

Related U.S. Application Data
(60) Provisional application No. 60/698,706, filed on Jul. 13, 2005.

(51) Int. Cl. G09G 5/00

(52) U.S. Cl. 345/660

(57) ABSTRACT

A method for building architectural scaled physical models uses additive manufacturing equipment to make a building model based on electronic data in a building model file, and uses subtractive manufacturing equipment to make a site model based on electronic data in a site model file. The building model file is modified to conform to requirements of additive manufacturing. The site model file is modified to conform to requirements of subtractive manufacturing. The modified building and site model files are compared to check that they are of the same scale. The modified building model file is submitted to additive manufacturing equipment to build the building model, and the modified site model file is submitted to subtractive manufacturing equipment to build the site model. After being built the building model and the site-model are integrated to form an architectural model.

### CROSS REFERENCE TO RELATED APPLICATIONS

This application claims priority benefit under 35 U.S.C. § 119(e) from provisional application No. 60/698,706, filed Jul. 13, 2005. The 60/698,706 application is incorporated by reference herein, in its entirety, for all purposes.

This application also relates to co-pending applications by the same inventor of this application and entitled “Applying Foliage and Terrain Features to Architectural Scaled Models” (application Ser. No. ______, filed ______), “Identification of Terrestrial Foliage Location, Type, and Height for Architectural Models” (application Ser. No. ______, filed ______), and “Determination of Scaling for Architectural Models” (application Ser. No. ______, filed

### FIELD OF THE INVENTION

The invention relates generally to architectural processes of building physical models to develop and communicate building design concepts. In particular, the invention relates to building physical architectural models using additive and subtractive manufacturing technologies along with satellite and/or aerial imagery.

### BACKGROUND OF THE INVENTION

Architects, builders, and real estate developers have been building physical representations (models) of their design concepts for centuries to help them both develop their design and communicate that design to their clients. These models typically involve the fabrication of a building model (typically a residential house or commercial building), the fabrication of a site model of the property's terrain, and the placement of miniature facsimile trees and/or shrubs on the site model.

The building model is a scaled three dimensional model that represents the architect's design of the proposed building. These building models have traditionally been fabricated by hand using cardboard-type materials (“chipboard” is a popular medium) by architects and/or model builders using X-ACTO® knives and glue to manufacture a miniature scaled model of the building design. Other materials can also be used such as plastics or metals, which are often cut to size using laser cutters.

The site models are typically scaled topographical representations of the land on which the building is to be constructed. The typical approach to constructing these site models is to cut out and stack-up cardboard layers, with each cut out layer representing a land elevation contour.

Once the building model and site model have been integrated together to form a combined model, the final assembly stage of the combined model is the placement of miniature foliage representing trees and/or shrubs. The miniature foliage may be simply decorative (i.e., randomly place on the site model with no correlation to the actual location of plants), or it may be a representation of the actual positioning of foliage that is intended to occupy the site with the building as part of an architect's landscape design.

Architectural models made in this traditional way are very time consuming to complete, often taking several weeks to finish. This is particularly vexing due to the fact that substantial, late changes may be made to the design that may necessitate a new model be built. The architectural models can also often be of mediocre quality due to the manual nature of the process which requires talent, skill, and care to be done well.

The traditional tangible statement of the architect's design concepts has been with the hand drafting of “blue prints” type drawings. With the advent of computer aided design (CAD) software tools into the architect community, architects have begun to use computer software programs to design buildings, replacing this traditional hand-drawn approach. Initially, these architectural CAD tools were two dimensional (2D) tools that simply brought the hand drafting process onto the computers. More recently, the architectural industry has begun to adopt three dimensional (3D) CAD tools to perform architectural design work.

### SUMMARY OF THE INVENTION

One embodiment of the present invention is a method for building architectural scaled physical models. Architectural electronic design data for a building model design is stored in a building model file and the building model file is examined to ensure compliance with requirements of additive manufacturing equipment, such as that used for rapid prototyping. Electronic design data for a site model is stored in a site model file and the site model file is examined to ensure compliance with requirements of subtractive manufacturing equipment, such as computer numerically controlled (CNC) milling machines or routers. Additionally, a determination is made whether the site model and the building model are the same scale, and a determination is made how the building model can be attached to the site model. The building model file is submitted to additive manufacturing equipment for fabrication and the site model file is submitted to subtractive manufacturing equipment for fabrication. Once complete, the fabricated building model and the fabricated site model are integrated together.

It is therefore an aspect of the present invention to utilize architectural electronic design data to build scaled physical models.

It is a further aspect of the present invention to provide an efficient and effective method for building architectural scaled physical models.

Another aspect of the present invention is utilization of the availability of electronic architectural design data (i.e. CAD data) and technology from non-architectural industries to develop a more efficient and effective process to building architectural scaled physical models which traditionally is time consuming, expensive, and of uneven quality.

One embodiment of the present invention is a method for manufacturing a scaled architectural model. The method includes storing electronic architectural design data in a building model file and modifying the building model file to ensure compliance with manufacturing requirements of additive manufacturing equipment. This produces a conforming building model file. The method also includes storing electronic site contour data in a site model file and modifying the site model file to ensure compliance with manufacturing requirements of subtractive manufacturing equipment. This produces a conforming site model file. The physical scales of the conforming building model file and the conforming site model file are then compared to ensure the two files are of substantially the same scale. The conforming building model file is then transmitted to the additive manufacturing equipment to produce a building model, and the conforming site model file is transmitted to the subtractive manufacturing equipment to produce a site model. The method then calls for the building model to be integrated with the site model.

Another embodiment of the present invention is a method for building architectural scaled physical models, wherein the method includes storing electronic architectural design data in a building model file and modifying the building model file to ensure compliance with manufacturing requirements of additive manufacturing equipment. This produces a conforming building model file. The method also includes storing electronic site contour data in a site model file, revising data in the site model file to provide for attachment points for model foliage, and modifying the site model file to ensure compliance with manufacturing requirements of subtractive manufacturing equipment. This produces a conforming site model file. The physical scales of the conforming building model file and the conforming site model file are then compared to ensure the two files are of substantially the same scale. A check is made that the building model represented by the conforming building model file can fit onto the site model represented by the conforming site model file. The conforming building model file is then transmitted to the additive manufacturing equipment to produce a building model, and the conforming site model file is transmitted to the subtractive manufacturing equipment to produce a site model. The method further includes integrating the building model with the site model and attaching the model foliage to the site model at the attachment points.

### BRIEF DESCRIPTION OF THE DRAWINGS

FIG. 1 illustrates a block diagram of the system architecture of a device for implementing embodiments of the present invention.

FIG. 2 illustrates a flow chart describing a process according the present invention.

FIG. 3 illustrates a conceptual diagram showing the integration of a building model made via an additive process with a site model made via a subtractive process.

### DETAILED DESCRIPTION

The present invention brings together disparate technologies from the fields of rapid industrial prototyping, machine tool manufacturing and airborne and/or satellite imagery to establish a new approach to building architectural physical models. Although the invention draws on technology from each of these disparate arts, the invention itself is most closely related to the art of architectural development tools.

Rapid prototyping is the automated construction of physical objects using solid freeform fabrication. The first techniques for rapid prototyping became available in the 1980's. Today, there is a wide range of rapid prototyping techniques that are used for a wide range of applications including to manufacture production quality parts in relatively small numbers. Some sculptors use the technology to produce complex shapes for fine art exhibitions. The major rapid prototyping techniques currently available include:
Fused deposition modeling: This technique extrudes hot plastic through a nozzle to building up a part.
Laminated object manufacturing: According to this technique, sheets of paper or plastic film are attached to previous layers by either sprayed glue, heating, or embedded adhesive, and then the desired outline of the layer is cut by laser or knife. The finished product typically looks and acts like wood.
Selective laser sintering (SLS): SLS uses a laser to fuse binder-coated metals, powdered thermoplastics, or other materials.
Stereolithography: This technique uses a laser to photocure liquid polymers.
Powder-binder printing: For this technique, layers of a fine powder are selectively bonded by “printing” a water-based adhesive from an inkjet print head. This includes both thermal phase change inkjet and photopolymer phase change inkjet.

In brief, rapid prototyping takes virtual designs (from computer aided design (CAD) software or from animation modeling software), transforms them into cross sections, still virtual, and then creates each cross section in physical space, one after the next until the model is finished. The virtual model and the physical model correspond almost identically.

In additive fabrication rapid prototyping, a machine reads in data from a CAD drawing, and lays down successive layers of liquid or powdered material, and in this way builds up the model from a long succession of cross sections. These layered cross sections which correspond to the virtual cross sections from the CAD model are fixed together (glued or fused automatically, often using a laser) to create the final shape. The primary advantage to additive construction is its ability to create almost any geometry, with the notable exception of trapped negative volumes.

The standard interface between CAD software and rapid prototyping machines is the .STL file format.

Computer Numerical Control (CNC) refers specifically to the computer “controller” that reads programming code (any of various programming codes, e.g., G-code, M-codes, DNC conversational, or APT code) instructions and drives an associated machine tool. The introduction of CNC machines radically changed the manufacturing industry, and as the number of machining steps that required human action has been dramatically reduced. When a machine tool is controlled by a CNC, curves are as easy to cut as straight lines, complex three dimensional structures are relatively easy to produce, and consistency and quality are improved because the frequency of errors is reduced.

CNC machines today are controlled directly from files created by CAD/CAM (Computer Aided Manufacturing) software packages, so that a part or assembly can go directly from design to manufacturing without the need of producing a drafted paper drawing of the manufactured component. In a sense, the CNC machines represent a special segment of industrial robot systems, as they are programmable to perform many kinds of machining operations (within their designed physical limits) like other robotic systems.

One standard interface between CAM software and CNC machines is G-Code instruction files.

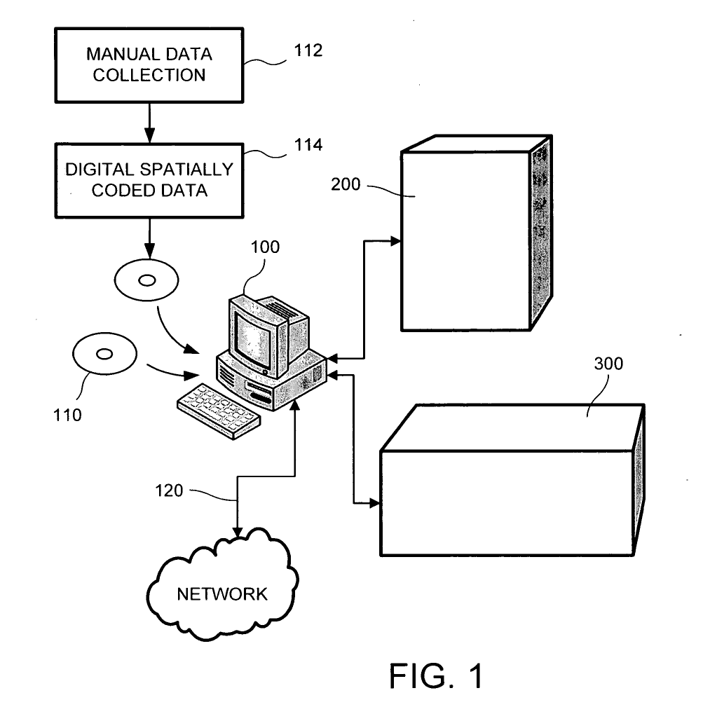

Referring to FIG. 1, system architecture of a device for practicing embodiments of the present invention is illustrated. A computer 100 is interfaced to both an additive manufacturing machine 200 and a subtractive manufacturing machine 300. The computer 100 handles electronic files containing data regarding both a building model and a site model and commands manufacture of models by the additive manufacturing machine 200 and the subtractive manufacturing machine 300 based on the electronic files. The data regarding building and site models may be generated on the computer 100 by an architect or may be loaded from a remote origin via portable media 110 or a communication channel 120. In the alternative, CNC subtractive manufacturing machines and/or additive manufacturing machines can be linked to a computer network and receive spatially coded data files and/or commands from any computer on the network.

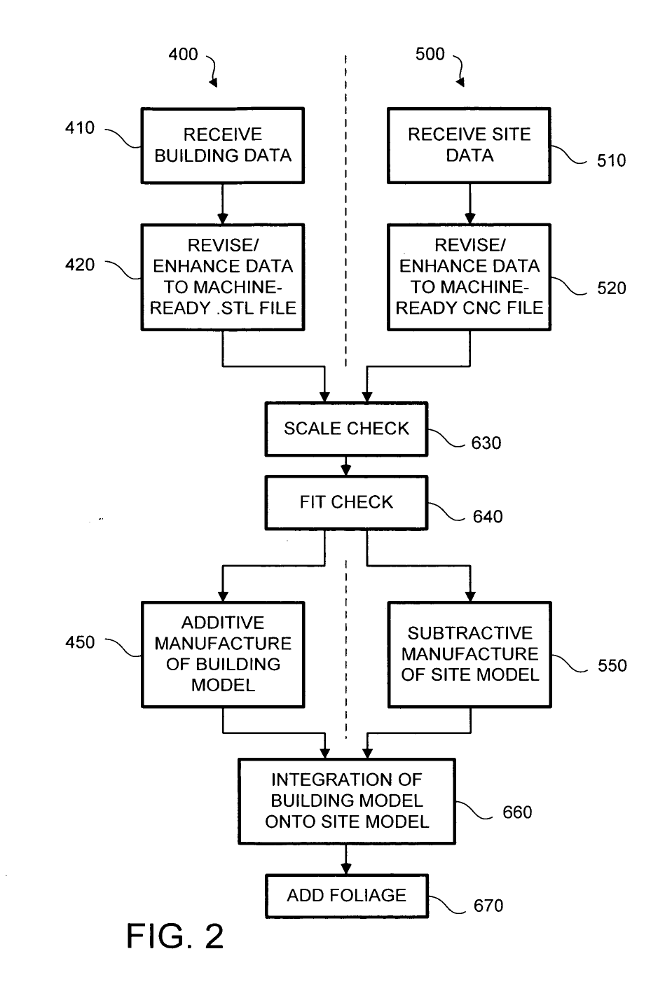

Referring to FIG. 2, a flowchart for a process by which architectural electronic design data can be used to build scaled physical models is illustrated. The process has a process flow 400 for making the building model, which is mostly separate from a process flow 500 for making the site model. The building model process flow 400 and the site model process flow 500 are conceptually parallel to one another and may be executed substantially contemporaneously with one another.

The building model process flow 400 begins the reception 410 of building model data from an architect or designer. The format the building model data is received in is any format known to those skilled in the art so long as it can be transformed or translated into a format that is compatible with CAD software. For example paper format blueprints can be scanned and captured to be placed into an electronic form. Non-3D CAD formats are translated into a 3D CAD format either by conversion or design translation. Thus, 2D CAD files, 3D CAD files, and .stl files can all be received into and utilized for a process according to this invention. For ease of description, the process as described below will presuppose that the building model data has been either delivered in, or has been converted into, the standard stereolithography output format which is known in the CAD art and for which the files have the file extension “.stl” (a standard output format for almost all 3D CAD software programs).

A building model .stl file received from the architect contains a complete description of the building model design, and is output from the architect's 3D CAD software package. Once received, the .stl file is examined to ensure suitability for manufacturing in additive manufacturing equipment 200 (refer to FIG. 1), which is commonly referred to as “rapid prototyping” equipment. Three dimensional printers are additive manufacturing machines 200 suitable for implementing the invention, and are commercially available as products manufactured by Z Corp, Stratasys, and 3D Systems.

A search of the data file is conducted for anomalies that would prevent successful manufacturing of the building model “part.” Any such anomalies identified are modified or repaired 420 so that manufacture of the model can be accomplished. Examples of repairs that are typically effected include making parts be “water tight” (i.e., no gaps, holes or voids in the model), and insuring that no features are below minimal manufacturing tolerances. Commercially available software programs are available for this purpose, such as Materialise's Magics, or proprietary analysis software may be used. Additional changes to the electronic model (e.g., changing the size of railings or fence posts) may be useful and can be accomplished with the use of 3D CAD programs. Examples of 3D CAD programs that can be successfully used to do this are Rhino FormZ, AutoCAD, and SolidWorks. As an alternative, .stl manipulation programs (such as Magics) can be used to make the changes to revise the building model data file.

Once the building model .stl file is determined to be suitable for manufacturing, a check 630 is made to ensure that the site model and the building model are of the same scale. For example, a check is made to confirm that both are “16th scale,” which means that 1 inch represents 16 feet at full scale. Additionally, a fit check 640 is made to make sure that they building model can be attached to the site model.

If both these checks are met, the building model .stl file is submitted 450 to the additive manufacturing equipment 200 to be built. The process this equipment performs is referred to as an “additive” process, since the part (in this case the building model) is typically built up one layer at a time by the rapid prototyping manufacturing equipment. Various types of media (e.g., plastic or plaster) can be used by the equipment to make the building models, and the media may be colored depending on the manufacturer and rapid prototype equipment selected.

Various post processing efforts are performed, depending on the additive manufacturing equipment selected. For example, when using a Z510 model three dimensional printer manufactured by Z Corp., once the building model is built up and has had suitable time to dry, the part is excavated from the Z510 machine and “de-powdered” to remove all excess material. The de-powdering is done because the Z510 uses a plaster-like powder material as its medium to build the parts it makes. The de-powdered building model can then be “infiltrated” with any of a variety of waxes, urethanes, or resins, depending on the desired surface characteristics for the building model. Once infiltrated, the building model may be hand finished as necessary to ensure the desired look, quality and finish.

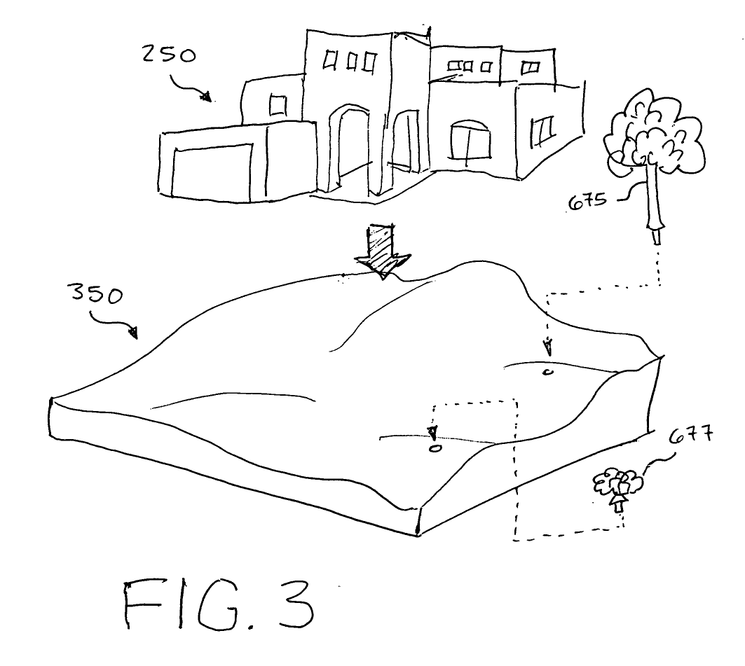

After the post processing efforts have been completed, the fabricated building model 250 is ready to be attached 660 to the site model 350 (refer to FIG. 3).

The site model process flow 500 can be performed in parallel to the building model process flow 400 to minimize overall process completion time.

The site model process flow 500 begins with the reception 510 of site model data from the architect, designer, or survey engineer. The site model data can be in various formats. Either paper format (e.g., plats) or electronic format (e.g., 2D CAD files, 3D CAD files, .stl files, etc.) can be utilized in the process. In order to be manufactured, non-3D formats must be translated into 3D formats, either by conversion or design translation. For ease of description, the process as described below will presuppose that the site model data has been either delivered in, or has been converted into, the standard stereolithography output format which is known in the CAD art and for which the files have the file extension “.stl”.

Once ready, the .stl file is converted 520 into a programming language (e.g., G-Code) that is used by subtractive manufacturing equipment, such as a CNC machine tool (e.g., a CNC milling machine or a CNC routing machine). This conversion can be done with off-the-shelf CAM (Computer Aided Manufacturing) software programs such as ArtCAM by Delcam plc (www.artcam.com).

Once the site model CNC program is determined to be suitable for manufacturing, a scale check 630 is made to ensure that the site model and the building model are of the same scale. For example, if one is sized at “16^{th} scale” (which meaning 1 inch on the model corresponds to 16 feet at full scale) the other will also need to be sized at that same 16^{th} scale. Additionally, a fit check 640 is made to ensure that the building model can be attached to the site model. If these checks are met, the site model CNC program is submitted 550 to the subtractive manufacturing equipment for building.

This manufacturing equipment is described as performing a “subtractive” process in that the part (in this case the site model) is created by taking material away from a block of material with milling or routing machinery. The site models can be made from various types of material, such as plastic modeling boards, Styrofoam, Medium Density Fiberboard or blocks of wood.

When the subtractive manufacturing equipment completes formation of the site model, it can then be hand finished as necessary to ensure the desired look, quality, and finish, after which the site model 350 is ready to be physically integrated 660 with the building model 250 (refer to FIG. 3).

In order to handle foliage modeling, either a foliage survey or landscaping plan of the property can be used or, an aerial and/or satellite imagery of the site model property may be obtained to perform digital image classification of the type of vegetation and the vegetations' location on the site. Examples of data sources for aerial and/or satellite imagery can be found on commercial web sites such as http://earth.google.com/, http://www.terraserver.com, and http://www.airphotousa.com, as well as web sites of government agencies responsible for agriculture or mapping, such as http://geography.usgs.gov/partners/viewonline.html. Other public and private sources for such data are also available. When used in the present invention, the satellite and/or aerial imagery data may be geo-referenced. Digital sources of imagery data (either satellite or aerial) are preferred, particularly those having a resolution of about 1 meter per pixel or less, those that are in color, and those that are taken with LIDAR (LIght Detection And Ranging) technology, although this is not meant as a limitation. The better the image quality is, the better it will provide meaningfully enhanced quality of foliage analysis.

Identification of foliage type and location is preferably conducted via one or more processes as disclosed in co-pending application Ser. No. ______, (filed ______), which claims priority from provisional patent application No. 60/698,707, is entitled “Identification of Terrestrial Foliage Location, Type, and Height for Architectural Models,” and which is hereby incorporated by reference into this application for all purposes. Identification of foliage type and location is satisfactorily performed using commercially available software. Algorithms for the identification of foliage from satellite and/or airborne images have been developed by Pollock (1994), Gougeon (1995), Brandtberg and Walter (1999), Wulder et al. (2000), and McCombs et al. (2003). In general, these algorithms perform digital image classification using the spectral information from the digital and/or airborne satellite imagery, and classify each individual pixel based on spectral information. This type of classification is generally termed “spectral pattern recognition.” The objective is to assign all pixels in the image to particular classes or themes (i.e. coniferous forest, deciduous forest, etc.). Commercial software packages that provide some functionality of this type include ecognition Forester by Definiens and Feature Analyst® by Visual Learning Systems.

As an alternative, or as a supplement, to software as described above, direct personal observations 112 of the foliage may be used to model the type, height, and location. Such direct data gathering is labor intensive, and thus usually disfavored, but may be a useful substitute or adjunct when readily available image data for the site is deficient or lacking. Such information would subsequently be entered into a data file 114 in the present invention for later manipulation. As an alternative, a landscape plan identifying location, type and size of foliage may be used.

Information identified by software (or through direct observation if need be) includes (1) identification of all the significant vegetation on the site, (2) the longitude and latitude location of each vegetation identified, (3) the type of each identified vegetation (i.e. evergreen, deciduous, shrub), and (4) the estimated height of each item of vegetation identified. This information is then integrated into the architect's site model to provide vegetation placement points in the site model.

At the ends of the building model process flow 400 and the site model process flow 500, these two process flows join together in a model integration process 660. Once the building model and site model are complete, these elements of the architectural model are integrated together. This integration involves attaching the building model to the site model and then securing 670 any foliage (i.e. trees 675 and shrubs 677) to the site model 350. Integration may also include a step of painting the landscape on the site and other finishing techniques.

Additional elements can be added to the integrated Model such as a wood-framed base and/or a glass or Plexiglas dust cover as appropriate to provide support and protection.

Finally, a quality inspection is performed to ensure the architectural model meets all specified standards and requirements.

The present invention provides several benefits. Compared to models built under the traditional manual approach, models built under the system and method of the present invention can be produced in significantly less time, at lower cost, and at consistently higher quality.

A system and method for building architectural scaled physical models have been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Any reference to a specific time, time interval, and instantiation of software is in all respects illustrative and not limiting. Further, any reference to claim elements in the singular, for example, using the articles “a,” “an,” or “the” is not to be construed as limiting the element to the singular.

What is claimed is:

1. A method for manufacturing a scaled architectural model, the method comprising:
storing electronic architectural design data in a building model file;
modifying the building model file to ensure compliance with manufacturing requirements of additive manufacturing equipment, thereby producing a conforming building model file;
storing electronic site contour data in a site model file;
modifying the site model file to ensure compliance with manufacturing requirements of subtractive manufacturing equipment, thereby producing a conforming site model file;
comparing physical scales of the conforming building model file and the conforming site model file to ensure the two files are of substantially the same scale;
transmitting the conforming building model file to the additive manufacturing equipment to produce a building model;
transmitting the conforming site model file to the subtractive manufacturing equipment to produce a site model; and
integrating the building model with the site model.

2. The method of claim 1, further comprising:
checking that the conforming building model file can fit onto the conforming site model file.

3. The method of claim 1, wherein the additive manufacturing equipment comprises rapid prototyping manufacturing equipment.

4. The method of claim 1, wherein the additive manufacturing equipment comprises a three dimensional printer.

5. The method of claim 1, wherein the subtractive manufacturing equipment comprises a computer numerically controlled milling machine.

6. The method of claim 1, wherein the subtractive manufacturing equipment comprises a computer numerically controlled router.

7. The method of claim 1, further comprising:
revising data in the conforming site model file to provide for attachment points for model foliage; and
attaching model foliage to the site model.

8. A method for building architectural scaled physical models, the method comprising:
storing electronic architectural design data in a building model file;
modifying the building model file to ensure compliance with manufacturing requirements of additive manufacturing equipment, thereby producing a conforming building model file;
storing electronic site contour data in a site model file;
revising data in the site model file to provide for attachment points for model foliage;
modifying the site model file to ensure compliance with manufacturing requirements of subtractive manufacturing equipment, thereby producing a conforming site model file;
comparing physical scales of the conforming building model file and the conforming site model file to ensure the two files are of substantially the same scale;
checking that the building model represented by the conforming building model file can fit onto the site model represented by the conforming site model file;
transmitting the conforming building model file to a three dimensional printer to produce a building model;
transmitting the conforming site model file to a computer numerically controlled milling machine to produce a site model;
integrating the building model with the site model; and
attaching the model foliage to the site model at the attachment points.
